(19) United States
(12) Patent Application Publication
(10) Pub. No.: US 2019/0075948 A1
(43) Pub. Date: Mar. 14, 2019

(54) Down pillow with recycled down material core and method

(71) Applicant: Ronie REUBEN, Town of Mount Royal (CA)

(72) Inventor: Ronie REUBEN, Town of Mount Royal (CA)

(21) Appl. No.: 15/732,070

(22) Filed: Sep. 14, 2017

(51) Int. Cl. A47G 9/10; A47G 9/02; A47G 9/04; B68G 1/00; B68G 7/06; B68G 3/00

(52) U.S. Cl. CPC A47G 9/10; A47G 9/0253; A47G 9/04; B68G 2001/005; B68G 7/06; B68G 3/00; B68G 1/00

(57) ABSTRACT

A down-fill pillow with a core formed from down feather sheet material pieces used in the fabrication of down insulated products. The size and shape of the pieces do not exceed predetermined sizes. The pieces may have a variety of shapes, such as in block or strip form or of irregular size if formed from trimmings of down sheet material in which is cut patterns for use in the fabrication of insulated articles. The down feather sheet pieces are placed in an envelope formed from one or more down feather sheets and the pieces entangle with one another due to their captive retention in the pillow envelope which restrains the pieces in close contact with one another and limited movement. When the head of a user person is rested on the down-fill pillow, it causes the mixture to compress and mold about the head while remaining entangled and recovering its loft when the head is removed. The method of forming the pillow core by the use of down feather sheet material pieces is also described.

### RELATED APPLICATION

The present application is related to Canadian Patent Application No. 2,914,878, filed Dec. 11, 2015 and entitled DOWN-FILL PILLOW CONSTRUCTION.

### TECHNICAL FIELD

The present invention relates to pillow structures and particularly to a down pillow having a core formed of down sheet material pieces and the method of fabrication. In a preferred embodiment the down sheet material pieces are formed from recycled trimmings from down sheet material sheets in which patterns are cut.

### BACKGROUND OF THE INVENTION

Pillow pouches are manufactured invarious constructions including polyurethane foams, polyester fill, feathers, down, and hard or soft core structures whereby to provide support to a user's head and neck during bedtime. Therapeutic pillows are also known but these use materials to provide firm support to the head and neck of the user person. Non-alergenic pillow structures utilize materials which are non-alergenic.

Several problems exist with feather or down fill pillows while these provide comfort in softness and warmth which are desirable features of such pillows. One major problem is the instability of the feathers or down disposed inside the pillow pouch wherein the feathers or down is unstable and has a tendency to migrate and clump in various areas of the pillow pouch when in use or manipulated in an attempt to obtain a more even distribution of the down inside the pouch. In others words, the feathers or down does not exhibit a constant density throughout the pillow pouch and there is therefore a constant need to shake the pillowcase and tamp it with the hand to try and maintain a more constant distribution of the feathers or down inside the pouch. This can become annoying to the user person.

Another problem with feather or down pillows is that the small feathers and down can escape from its pouch and pillow case, particularly during manipulation, tamping and cleaning, and inhaled by the user person. If the person is allergic to feathers, then one has to revert to the use of pillows having non-allergic fill material which do not have the comfort and warm equivalent to feather or down filled pillows. Feathers and down are unstable products and in the fabrication of pillows the pouches are often filled by hand or blown into the pouch. Such manufacturing methods can be hazardous to the health of the factory workers and does not ensure a constant volume of feathers or down being inserted into the pouch. Still further, the use of down is expensive although it is known to be one of the best insulating products while exhibiting softness to a user's face when sleeping and is capable of restoring its shape after having been compressed during use.

In my U.S. Pat. No. 6,025,041, entitled “Down Feather Sheet” there is disclosed the construction of a down feather sheet wherein the down is mixed with a binder, such as glue particles or binding synthetic fibers or a mixture thereof, to form a substantially homogeneous sheet for use as a thermal insulator. Down which is a natural fiber is known to have excellent thermal insulating properties due to the fact that it is formed of clusters having a plurality of fibers radiating from a cluster core with the fibers having a multitude of minuscule hairs to trap air pockets creating an effective thermal barrier and therefore an excellent insulator. These clusters of tiny hairs, up to 2 million filaments for every ounce of down that crisscross every which way cannot be synthetically duplicated. My down feather sheet was developed for preventing the feather down from shifting and clumping when used in the construction of thermally insulated articles where previously the down was inserted loosely between fabric sheets.

From my study of down clusters and the fact that I have been successful in harnessing the down in a homogeneous structure, I have come to realize that by trapping the clusters in a 3-dimensional interconnected filament structure, a multitude of air pockets are formed by the binder and the filaments of the down to trap the clusters. Various sizes, down to miniscule air pockets are formed between the cluster filaments and their multitude of hairs and the spaces between the filament structure. This created the best known thermal insulator. Down has several advantages such as providing warmth, breathability, sound insulation, compressability and loft restoration, its biodegradable, ecological and provides warmth in the cold winter month and a cooling effect in hot weather conditions.

In my above referenced pending patent application I have utilized my down feather sheet to create the envelope of the pillow and disclosed that the core can consist of one or more sheets of down feathers. By doing so, I have resolved the problem of the core material being displaced during use or feathers and down from forming clumps.

During the fabrication of products using down feather sheets of the type disclosed in my aforementioned U.S. Pat. No. 6,025,041 and my U.S. Pat. No. 9,380,893 entitled “Thermally Insulating Stretchable Down Feather Sheet and Method of Fabrication”, trimmings are produced when cutting pattern pieces in these sheets. Due to the advantages and higher cost of down material as compared to synthetic insulation, it is desirable to recycle these trimmings into other useful products. However, it is not practical to separate the down from its attachment to the scrim sheets.

In searching for a useful use for these trimmings, I have experimented with its use as the core element. However, for comfort the size and shape of the trimmings have to be within predetermined dimensions whereby the user person would not experience any discomfort around is face and head during use. Also, these down feather pieces cut from my down feather sheets would have to be substantially stable within the pillow envelope to prevent them from clumping.

### SUMMARY OF THE INVENTION

It is a feature of the present invention to overcome the above mentioned disadvantages and to recycle the down sheet trimmings into a useful product.

Another feature of the present invention is to provide a down-fill pillow construction wherein the core of the pillow is made of a plurality of down feather sheet pieces cut from down feather sheets in specific sizes and shapes. Another feature of the present invention is to provide a down-fill pillow construction which utilizes a core body of down feather sheet trimmings and wherein the core is surrounded by one or more down material sheets secured to form an envelope in which the trimmings are retained captive.

A further feature of the present invention is to provide a down-fill pillow construction wherein the core body is formed by a plurality of cut pieces from a down feather sheet and wherein said cut pieces are in strip form, or cube form or any other suitable form wherein to form an entanglement when captive in a pillow envelope to prevent the displacement thereof during use.

Another feature of the present invention is to introduce polymer material mixed with the down feather pieces to improve the loft of the pillow while reducing the cost of the core material.

Another feature of the present invention is to provide a novel method of forming a down-fill pillow using pieces of down feather sheet material cut to form or recovered from waste material produced by cutting patterns in down feather sheets.

According to the above features, from a broad aspect, the present invention provides a down-fill pillow comprised of a fabric pouch in which is captively retained in close fit a pillow envelope formed from one or more down feather sheets secured such as to form said envelope, said one or more down feather sheets being formed by a layer of down material of predetermined thickness held captive. A down material core is encapsulated by the envelope. The down material core is formed by a plurality of down feather pieces cut from down feather sheets. The down feather pieces are of sufficient quantity to fill the envelope and are subjected to limited movement with one another when the head a user person is rested on the down-fill pillow causing the down feather pieces to compress and mold about the head while remaining entangled with one another and recovering its loft when the head is removed.

According to another broad aspect of the present invention there is provided a method of forming a down-fill pillow from down feather sheet material. The method comprises the steps of:

(i) forming an envelope from one or more down feather sheets, said down feather sheets having a layer of down feather material of predetermined thickness mixed with a binder and held captive;

(ii) forming down feather pieces for use as a core for the down fill pillow;

(iii) stuffing the envelope with a substantially predetermined volume of the down feather pieces;

(iv) closing and securing the envelope, and

(v) placing the envelope in a fabric pouch to form the down-fill pillow.

### DESCRIPTION OF THE DRAWINGS

A preferred embodiment of the present invention will now be described with reference to the accompanying drawings in which:

FIG. 1 is a perspective view of the down-fill pillow, partly fragmented, illustrating the internal construction of the envelope with down material pieces forming the core of the pillow;

FIGS. 2A to 2C are enlarged views of the core formed of irregular size pieces of down feather sheet material in various forms including trimmings and further illustrating different types of binder material that can optionally be mixed with the down feather pieces,

FIG. 3A is a cross-section view through the pillow envelope illustrating the core formed from recycled trimmings of down feather sheet material and optionally mixed with different binder materials,

FIG. 3B is a cross-section view through the pillow envelope illustrating the core formed from down sheet material pieces of strip form mixed with a polymeric fill material having loft properties,

FIG. 4A is a top view of a portion of a down feather sheet in which is cut down feather pieces of rectangular strip form and of block form for use as the core filler of the pillow,

FIG. 4B is a top view of a portion of a down feather sheet in which is cut pattern pieces for the fabrication of an article of apparel, such as a jacket, and wherein trimmings are produced by surplus material exteriorly of the pattern pieces, and

FIGS. 5A and 5B are cross-section views of down sheets produced in accordance with my prior art patents illustrating a down feather sheet with a binder and having opposed free surfaces and a down feather sheet with a binder having opposed scrim sheets.

### DETAILED DESCRIPTION

Referring to the drawings and particularly to FIG. 1, there is shown a down-fill pillow 10 constructed in accordance with the present invention. The down-fill pillow 10 is comprised of a pillow envelope 11 having a core 12 and held captive in a fabric pouch 13 through a securable open end 14. As herein shown, the pillow envelope 11 is comprised of two down feather sheets 15 and 15′ secured together by stitch seams 16 and having an open-end 17 through with the material of the core 12 can be inserted and later held captive by a zipper closure member 18 or stitches.

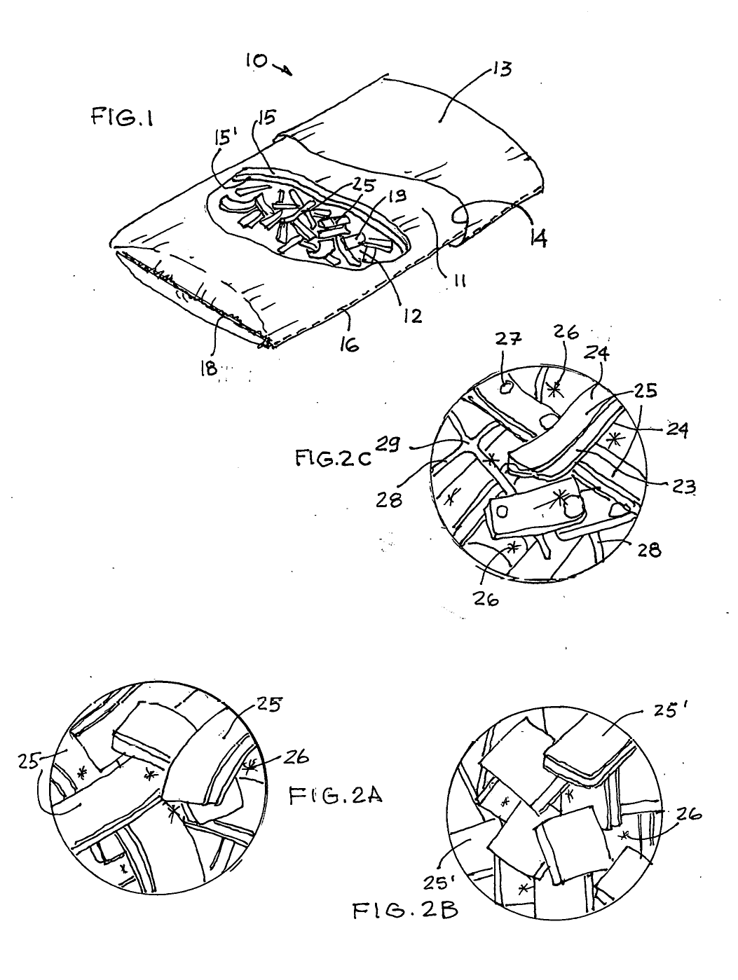

With further reference to FIGS. 2 to 5B, there is illustrated core materials formed from down sheet material, such as in the forms illustrated in FIGS. 5A and 5B. As shown in FIG. 5A the down material sheet 50 is formed by a core 51 down feathers 52 mixed with a binder, herein glue coated fibers 53 known as “BICO”, trademark, and subjected to a heat treatment. The opposed surfaces 54 of the core 51 are exposed. In FIG. 5B, scrim sheets 55 are bound to the opposed surfaces of the core 51 of the down material sheet 50′ when subjected to the heat treatment.

FIGS. 2A to 2C illustrates different shapes and types of down material pieces used for the core of the pillow. These material pieces are cut from down feather sheets, such as illustrated in FIG. 4A and formed from sheet material of the type illustrated in FIG. 5A or 5B, with the sheet of FIG. 5B having one or two scrim sheets. As shown in FIG. 2A, the down material pieces 25 are in strip form varying in lengths of from about 3 to 6 inches or more providing excellent entanglement when held captive in the pillow envelope 11. As herein shown some down dusters 26 become released from the strip pieces 25 when displaced an in friction with one another. In FIG. 2B, the down feather pieces 25′ are in cube of block form and also provide excellent entanglement when held captive in the pillow envelope 11. With respect to FIG. 2C, trimmings pieces 20 are used for the core filling. These trimmings pieces 20 are produced by surplus down feather sheet material from sheet(s) 21 in which pattern pieces 22 are cut, as illustrated by FIG. 4B.

As shown in FIG. 4B, when fabricating insulated articles, such as articles of apparel, the wastage material, namely the trimmings, is usually in the order of from 10% to 15% of the sheet material used. These trimmings 20 are of irregular sizes and shapes and they are collected and sorted for use in the fabrication of the core 12. Those pieces that exceed a predetermined size are put aside to be re-cut to form further acceptable core trimmings. The down feather sheets 22 can have different thicknesses and density of down 23 held captive by a binder, as illustrated in FIGS. 5A and 5B, and in most cases have opposed scrim sheets 55. A predetermined quantity of these trimmings of predetermined sizes when stuffed in the pillow envelope 11 are held together by entanglement and are capable of only limited movement with one another. When a load, such as a user person's head, is rested on the down-fill pillow 10, it causes the irregular size pieces to compress and mold about the head while remaining entangled with one another and recovering its loft when the head is removed.

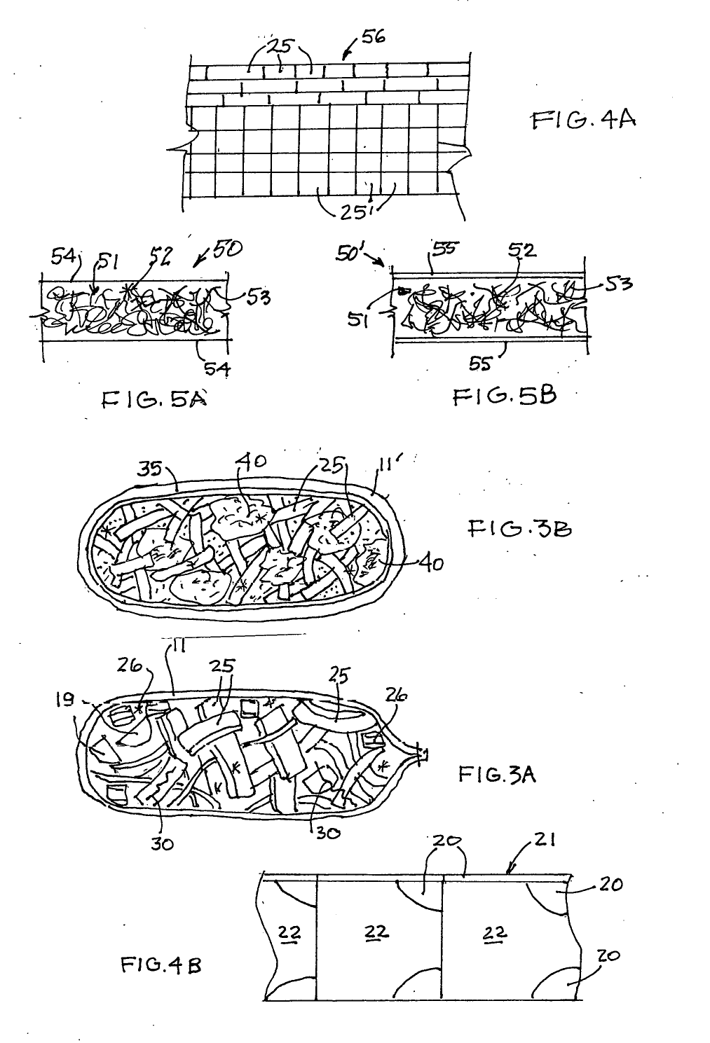

When the down material pieces are in strip-form, such as the strips 25 illustrated in FIGS. 2A and 2C they provide excellent entanglement. These strip form down feather pieces 25 when mixed with a predetermined volume of irregular shaped trimmings such as 19 shown in FIG. 3A, improves the entanglement and prevent the formation of dumps in the core material.

As shown in FIG. 2C, the down feather pieces 25 expose the down material 51 on the sides of the pieces and the friction between the pieces or trimmings will cause some down dusters 26 to escape into the entangled mixture and be trapped by the entanglement of the pieces 25. In order to better stabilize the core 12 formed by these pieces 25 or trimmings 20 and the release of down dusters 26, binder material can be added to the mixture. As shown in FIG. 2C, heat activated material in the form of powder glue 27 and/or polymeric glue coated fibers 28, capable of melting or softening to bind together at their crossings 29, is mixed with the core material pieces 25 and the pillow envelope is subjected to heat to form an improved secured entanglement of the core material by some of the core pieces 25 binding with one another in some parts thereof and in at least parts of the mixture The binding fibers may also stretch with the entangled pieces when displaced by compression of the pillow. The fibers 28 can be polyester fibers or crimped polymeric fibers 30 as shown in FIG. 3A. It is conceivable that other materials such as chemically treated pellets or capsules can be added to the mixture to release a pleasant scent or provide a multitude of other hygienic benefits.

FIG. 3B illustrates another variant of the down-fill pillow 10 of the present invention wherein the core material is formed of down feather pieces, such as the strips 25 mixed with polymer fibers 40 in predetermined quantities to provide a less expensive mixture while providing excellent loft. However, these fibers do not have the same thermal efficiency has does the down pieces 25. Another modification illustrated herein is that the down core is held captive in a pouch 35 formed of light weight synthetic fabric such as that used for the scrim sheets 55 and held captive therein. This makes it possible to remove the core from the pillow envelope 11. The envelope 11 is herein illustrated as being formed from a single down feather sheet 11′.

The method of fabricating the down-fill pillow 10 of the present invention, as illustrated in FIG. 1, comprises the steps of forming down feather pieces from a down feather sheet or collecting the waste material trimmings from patterns cut in down feather sheets, such as sheets 50 and 50′ shown in FIGS. 5A and 5B. These trimmings are usually of irregular shape and size and are sorted to remove trimmings exceeding predetermined sizes. The removed trimmings can be re-cut to acceptable size and preferably in strip form. The pillow envelope 11 is stuffed with a predetermined volume of the down feather pieces from its open end 17 which is then reclosed by a zipper 18, as shown in FIG. 1. The envelope 11 is then inserted in the fabric pouch 13, which is closed by a zipper or other suitable closure means not shown, but obvious. As above described predetermined quantities of binders or synthetic fiber material can be mixed with the down material pieces.

It is within the ambit of the present invention to cover all obvious embodiments and modifications of the preferred embodiment described herein provided such fall within the scope of the appended claims.

1. A down-fill pillow comprising a fabric pouch in which is captively retained in close fit a pillow envelope formed from one or more down feather sheets secured such as to form said envelope, said one or more down feather sheets being formed by a layer of down material of predetermined thickness and density mixed with a binder, a down material core encapsulated by said envelope, said down material core being formed by a plurality of down feather pieces cut from a bound down feather sheets, said down feather pieces being is sufficient quantity to fill said envelope which subjected to limited movement with one another when the head a user person is rested on said down-fill pillow causing said down feather pieces to compress and mold about said head while remaining entangled with one another and recovering its loft when said head is removed.

2. The down-fill pillow as claimed in claim 1 wherein said down feather pieces are of substantially the same shape

3. The down-fill pillow as claimed in claim 1 wherein said down feather pieces are irregular size pieces formed by trimmings produced by patterns cut in said bound down feather sheets, some of said trimmings being re-sized not to exceed a predetermined maximum size. and wherein some of said trimmings are of irregular shape with a predetermined volume of said trimmings being in strip-form, said down material core being constituted by an entangled mixture of said trimmings.

4. The down-fill pillow as claimed in claim 1 wherein said down feather pieces are one of strip form and or cube form down feather pieces and form an entangled stable mixture when a predetermined volume of said down feather pieces are retained captive in said envelope

5. The down-fill pillow as claimed in claim 1 wherein there is further provided polymer fibers mixed with said down feather pieces, said polymer fibers providing loft to said mixture and capable of recovering its loft after compression.

6. The down-fill pillow as claimed in claim 1 wherein said mixture of irregular size pieces of down feather sheet material are strips of down feather sheets of irregular thickness, shape and length.

7. The down-fill pillow as claimed in claim 1 wherein a heat activated binder material is mixed with said mixture of irregular size pieces of down feather sheet material, and further wherein said fabric pouch is subjected to a heat treatment to melt or soften said heat activated binder material to bind said mixture in at least parts thereof to form a stable and compressable down material core capable of restoring its form after being compressed.

8. The down-fill pillow as claimed in claim 6 wherein said binder is one of a powder glue and/or glue coated polymeric fibers capable of melting or softening to bind at their crossings and with said trimmings of said mixture when subjected to a heat treatment.

9. The down-fill pillow as claimed in claim 6 wherein said binder is constituted by one of stretchable fibers and crimped fibers capable of bonding with at least some of said trimmings of said mixture when subjected to a heat treatment to form a stable and stretchable down material core.

10. The down-fill pillow as claimed in claim 5 wherein said strips of down feather sheet material have a length in the range of from about ½ inches to 6 inches or more, said strips being entangled with one another to provide stability of said down material core with limited movement to adjust to pressure created by said head of a user person rested thereon with limited separation as compared to loose down material.

11. The down-fill pillow as claimed in claim 1 wherein said down feather pieces are a mixture of irregular size pieces of down feather sheet material constituted by wastage of down feather sheets in which patterns are cut out for the fabrication of insulation pieces to be used with insulated products

12. The down-fill pillow as claimed in claim 2 wherein said trimmings when captive in said fabric pouch will release down dusters in the said mixture, said down dusters being held captivated by said entanglement of said trimmings throughout said mixture.

13. The down-fill pillow as claimed in claim 1 wherein said one or more down feather sheets forming said envelope are stitched together to form an envelope having an opening to receive said core mixture, and a zipper closure to close said opening to encapsulate said mixture in said envelope.

14. The down-fill pillow as claimed in claim 1 wherein said down feather pieces are disposed in a light weight pouch which is sized for close-fit in said pillow envelope and captive therein.

15. A method of forming a down-fill pillow from down feather sheet material, said method comprising the steps of:
(i) forming an envelope from one or more down feather sheets, said down feather sheets having a layer of down feather material of predetermined thickness mixed with a binder and held captive between opposed scrim sheets;
(ii) forming down feather pieces for use as a core of said down fill pillow,
(iii) stuffing said envelope with a substantially predetermined volume of said down feather pieces;
(iv) closing and securing said envelope, and
(v) placing said envelope in a fabric pouch to form said down-fill pillow.

16. The method as claimed in claim 15 wherein said step (ii) comprises cutting predetermined size and shape down feather pieces from a bound down feather sheet to form substantially like pieces, said bound down feather sheet being comprised of one of (a) a down feather material sheet comprised of down mixed with a binder and having opposed exposed flat surfaces, (b) a down feather material sheet comprised of down mixed with a binder and having a scrim sheet bound to one of both of said opposed exposed flat surfaces.

17. The method of claim 15 wherein said step (ii) comprises collecting down feather sheet trimmings from bound down feather sheets in which pattern pieces are cut, and sorting said down feather sheet trimmings to remove trimmings exceeding a predetermined size, and wherein there is further provided the step of cutting said trimmings exceeding said predetermined size into pieces suitable for mixture with said collected trimmings.

18. The method of claim 15 wherein after said step (iii) there is provided the step of placing a predetermined volume of said down feather pieces in a light weight pouch, said step (iii) further comprising stuffing said enveloped with said light weight pouch filled with a predetermined volume of said down feather pieces.

19. The method of claim 15 wherein prior to step (iv) there is provided the step of mixing a heat activated binder material with said trimmings, and after step (v) there is provided the further step of subjecting said envelope to heat treatment to melt or soften said heat activated binder material to bind said mixture in at least parts thereof to form a stable down material core.

20. The method of claim 15 wherein prior to step (iii) there is provided the step of mixing a heat activated binder material with said down feather pieces, and after step (iv) there is provided the further step of subjecting said envelope to heat treatment to soften said heat activated binder material to bind said mixture in at least parts of said mixture to form a stable down material core.

21. The method of claim 15 wherein after step (ii) there is provided the further step of mixing polymer fibers in predetermined quantity with said down feather pieces.
